(19) United States
(12) Patent Application Publication
(10) Pub. No.: US 2013/0056286 A1
(43) Pub. Date: Mar. 7, 2013

(54) SELF CHECKOUT TERMINAL AND METHOD

(71) Applicants: Masato Watabe, Shizuoka-ken (JP); Hidehiro Naito, Shizuoka-ken (JP); Hiroyuki Ueda, Shizuoka-ken (JP); Shinji Nakatake, Shizuoka-ken (JP); Masahide Ogawa, Shizuoka-ken (JP)

(72) Inventors: Masato Watabe, Shizuoka-ken (JP); Hidehiro Naito, Shizuoka-ken (JP); Hiroyuki Ueda, Shizuoka-ken (JP); Shinji Nakatake, Shizuoka-ken (JP); Masahide Ogawa, Shizuoka-ken (JP)

(73) Assignee: TOSHIBA TEC KABUSHIKI KAISHA, Tokyo (JP)

(21) Appl. No.: 13/603,655

(22) Filed: Sep. 5, 2012

(30) Foreign Application Priority Data
Sep. 5, 2011 (JP) 2011-192326

(51) Int. Cl. G01G 9/00; G01G 17/00

(52) U.S. Cl. 177/1; 177/4

(57) ABSTRACT

A self checkout terminal comprises a measurement section configured to measure the weight of a commodity, a shooting section configured to shoot an image, a recognition unit configured to recognize the commodity from the shot image, an extraction unit configured to extract the commodity information satisfying the recognized commodity from a commodity master file storing the commodity information including the weight of the commodity, wherein the commodity information is information satisfying the commodity, a selection unit configured to select the commodity information including a weight approximately the same as the measured weight from the extracted commodity information and a registration unit configured to carry out sales registration on the commodity satisfied by the selected commodity information.

### CROSS-REFERENCE TO RELATED APPLICATION

This application I s based upon and claims the benefit of priority from Japanese Patent Application No. 2011-192326, filed Sep. 5, 2011, the entire contents of which are incorporated herein by reference.

### FIELD

Embodiments described herein relate to a self checkout terminal and a method.

### BACKGROUND

In recent years, the following technology was disclosed. In a POS (Point Of Sales) terminal and the like, a commodity is recognized from a shot image by utilizing an object recognition technology with reference to a commodity image stored in a PLU (Price Look Up) file, and sales registration is carried out on the recognized commodity.

### BRIEF INTRODUCTION OF THE DRAWINGS

FIG. 1 is a schematic diagram showing total system compositions;

FIG. 2 is a solid diagram showing a self checkout terminal;

FIG. 3 is a solid diagram showing a state of maintaining a shopping bag on a maintenance arm;

FIG. 4 is a block diagram showing an electric hardware composition of a settlement terminal;

FIG. 5 is a drawing describing a commodity master file;

FIG. 6 is a block diagram showing function compositions of the settlement terminal to which the present embodiment relates;

FIG. 7 is a flow chart showing the steps of the sales registration processing of a commodity carried out by the settlement terminal.

### DETAILED DESCRIPTION

A self checkout terminal comprises a measurement section configured to measure the weight of a commodity, a shooting section configured to shoot an image, a recognition unit configured to recognize the commodity from the shot image, an extraction unit configured to extract the commodity information satisfying the recognized commodity from a commodity master file storing the commodity information including the weight of the commodity, wherein the commodity information is information satisfying the commodity, a selection unit configured to select the commodity information including a weight approximately the same as the measured weight from the extracted commodity information and a registration unit configured to carry out sales registration on the commodity satisfied by the selected commodity information.

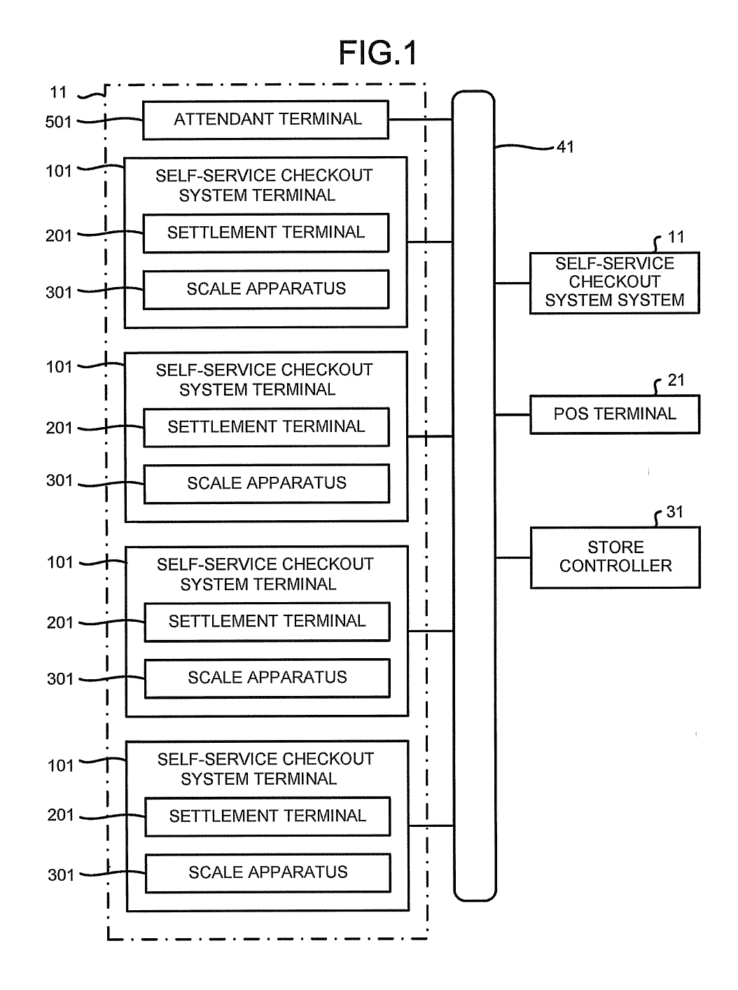

FIG. 1 is a schematic diagram showing total system compositions. A system of the present embodiment is connected with a plurality of self checkout systems 11, a plurality of POS (Point Of Sales) terminals 21 and a store controller 31 by a communication network 41. In the self checkout systems 11, a plurality of self checkout terminals 101 share one attendant terminal 501. The self checkout terminals 101 are terminals carrying out settlement on the commodity purchased by the own operation of a customer. In the present embodiment, the self checkout terminal 101 comprises a settlement terminal 201 and a scale apparatus 301.

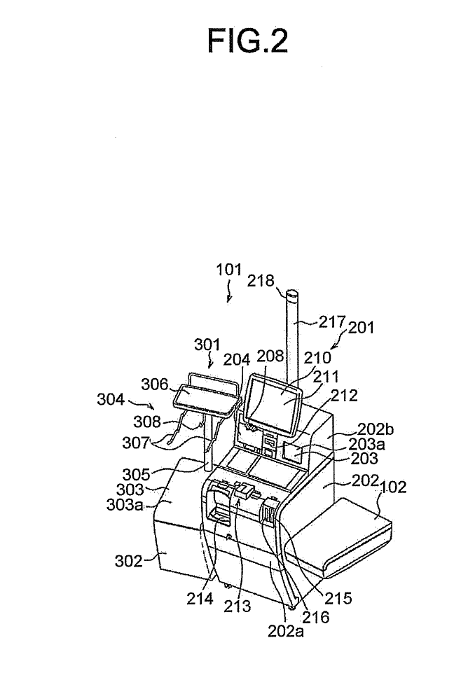

FIG. 2 is a solid diagram showing the self checkout terminal. As described above, the self checkout terminal 101 comprises the settlement terminal 201 and the scale apparatus 301.

The settlement terminal 201 comprises a housing 202, and a commodity basket bearing platform 102 for bearing a basket (not shown in figures) in which the commodity to be purchased by the customer is put is protruded from the side part of the housing 202.

The housing 202 of the settlement terminal 201 comprises a base housing 202a placed on a floor and an upper housing 202b borne on the upper surface of the base housing 202a. The front surface of the base housing 202a is inclined in the manner that the more the front surface approaches a lower part, the more the projected area of the base housing 202a is decreased. Namely, the base housing 202a is in a shape that the more the base housing approaches the power part, the more the base housing deviates towards an inner side.

In addition, the settlement terminal 201 is equipped with a shooting section 203 such as a colorized CCD (charged coupled device) image sensor or a colorized CMOS (complementary metal oxide semiconductor) image sensor and the like on the side of the commodity basket bearing platform 102 of the upper housing 202b. In addition, the settlement terminal 201 is equipped with a printer cover 204 on the opposite side of the commodity basket bearing platform 102 of the upper housing 202b. In addition, the settlement terminal 201 is equipped with a card socket 212 between the shooting section 203 and the printer cover 204.

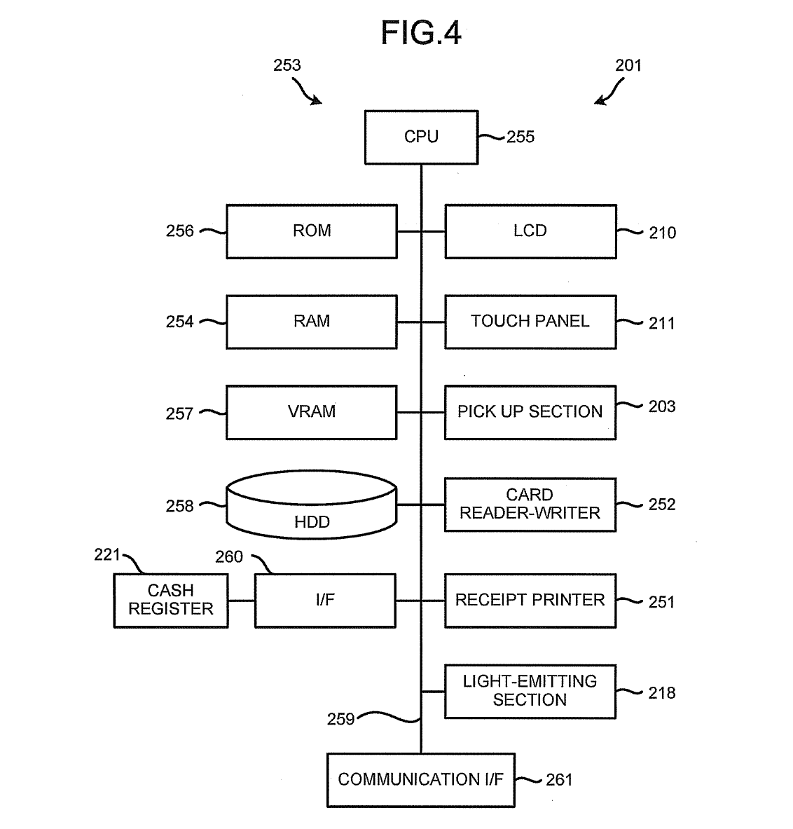

The settlement terminal 201 is equipped with the built-in shooting section 203 in a reading window 203a formed by a glass plate. The shooting section 203 is used for shooting an image including the image of the commodity subjected to the sales registration. In the present embodiment, the shooting section 203 carries out the shooting of 30 fps (frames per second) of motion images. Afterwards, the shooting section 203 stores frame images which are shot in sequence according to preset frames per second in an RAM 254 (referring to FIG. 4)

In addition, the settlement terminal 201 is provided with the printer cover 204 which is freely opened and closed relative to the upper housing 202b on the upper housings 202b. The printer cover 204 comprises a receipt output port 208. The settlement terminal 201 is equipped with a built-in receipt printer 251 (referring to FIG. 4) at the inner side of the printer cover 204. Moreover, the settlement terminal 201 outputs a receipt which is printed by the receipt printer 251 and is not shown in the figures from the receipt output port 208.

In addition, the settlement terminal 201 is equipped with a built-in card reader-writer 252 (referring to FIG. 4) in the card socket 212, and the card reader-writer 252 is a magnetic card reader-writer capable of carrying out the reading and the writing of data on a magnetic card. A credit card is inserted into the card socket 212 as a magnetic card.

In addition, the settlement terminal 201 comprises an LCD (liquid crystal display) 210 on the upper housing 202b, and the LCD 210 is used as a display section displaying the commodity name, the weight, the price or the image and the like of the commodity subjected to the sales registration and the commodity information satisfying the commodity towards a shopper. In addition, the settlement terminal 201 is accumulatively equipped with touch panels 211 on the picture of the LCD 210, and the touch panels 211 are provided with various keys accepting the input of the commodity code and the like of the commodity subjected to the sales registration, enter keys needed for the settlement of commodity price, and the like.

In addition, the settlement terminal 201 is equipped with a built-in charge machine 221 (referring to FIG. 4) for coins and paper money in the base housing 202a. In addition, as one part of the charge machine 221, the settlement terminal 201 is equipped with a coin throwing port 213 on the upper surface of the center of the base housing 202a and is equipped with a coin exhaust port 214 on the left side of the coin throwing port 213. In addition, the settlement terminal 201 is equipped with a paper money throwing port 215 and a paper money exhaust port 216 on the right side of the coin throwing port 213. Such a charge machine 221 comprises a mechanism section capable of carrying out the processing of the coins and the paper money and a control section (all not shown in the figures) controlling the mechanism section. For the structure of the mechanism section capable of carrying out the processing of the coins and the paper money and the processing sequence and the like of the control section controlling the mechanism section, as their contents are known, the description is omitted.

In addition, the settlement terminal 201 is equipped with a display pole 217 from the back surface of the base housing 202a, and the display role 217 is used as an alarming apparatuses displaying the current state of the self checkout terminal 101. The display pole 217 comprises a light-emitting section 218 selectively emitting blue light and red light at a top end part.

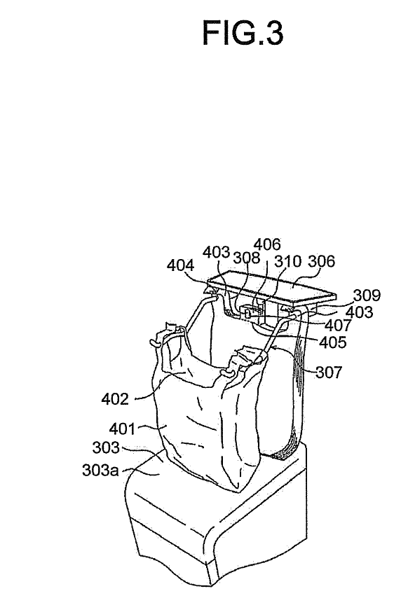

Next, the scale apparatus 301 is described by using FIG. 2 and FIG. 3. FIG. 3 is a solid diagram showing a state of maintaining a shopping bag on a maintenance arm. The scale apparatus 301 comprises a scale pan 303 at the upper part of a scale housing 302, and the scale apparatus 301 is a measurement section measuring the weight of the commodity placed on the scale pan 303. In addition, the scale apparatus 301 is provided with a bag maintenance tool 304 on the scale pan 303. More particularly, the scale pan 303 comprises a bearing platform 303a on an upper surface. Moreover, the scale apparatus 301 is provided with the bag maintenance tool 304 on the bearing platform 303a. Therefore, observed from the bag maintenance tool 304, the scale pan 303 forms a pedestal. Namely, the scale apparatus 301 is provided with a pole-shaped arm supporting section 305 at a central part at the back of the bearing platform 303a. In addition, the scale apparatus 301 is fixedly equipped with a temporary bearing platform 306 for bearing an article at the upper end of the arm supporting section 305. The temporary bearing platform 306 is a platform whose upper surface is a flat plane and which is furthermore used for the purpose of temporarily bearing the commodity whose image is shot by the shooting section 203 of the settlement terminal. The bearing platform 303a and the temporary bearing platform 306 together play a role as a bearing section for bearing the commodity whose commodity code is input.

In addition, the scale apparatus 301 is provided with one pair of maintenance arms 307 and a hook section 308 on the lower surface of the temporary bearing platform 306. Namely, the scale apparatus 301 is fixedly equipped with arm mounting components 309 (referring to FIG. 3) at positions at two ends of the lower surface of the temporary bearing platform 306. Particularly, the arm mounting components 309 are fixed at the positions at the two ends of the lower surface of the temporary bearing platform 306 by various fixation methods such as bolt fixation, adhesion fixation and the like in the scale apparatus 301. Afterwards, the maintenance arms 307 are embedded in all the arm mounting components 309 in the scale apparatus 301. In addition, the scale apparatus 301 is fixedly equipped with a hook section mounting component 310 (referring to FIG. 3) at the central position of the lower surface of the temporary bearing platform 306. Particularly, the hook section mounting component 310 is fixed at the central position of the lower surface of the temporary bearing platform 306 by various fixation methods such as the bolt fixation, the adhesion fixation and the like in the scale apparatus 301. Afterwards, the hook section 308 is embedded in the hook section mounting component 310 in the scale apparatus 301.

For instance, in order to maintain the shopping bag 401 comprising a holding component such as a plastic bag and the like provided for the customer in a supermarket and the like, namely the shopping bag 401 which comprises an opening section 402 and one pair of handles 403 protruded from the opening section 402 and is furthermore folded in the manner that the handles 403 are positioned on two sides, the maintenance arms 307 maintain the shopping bag 401 in a state of piercing the pair of handles 403. In order to realize such a maintenance state, the shopping bag 401 comprises silts 404 on the handles 403. In addition, the shopping bag 401 comprises one pair of lug sections 406 which are located between the pair of handles 403 and are furthermore capable of falling off at perforation 405. Moreover, the lug sections 406 comprise suspension holes 407. The hook section 308 penetrates through the suspension holes 407, so as to maintain the shopping bag 401 together with the maintenance arms 307.

FIG. 4 is a block diagram showing an electric hardware composition of the settlement terminal. The settlement terminal 201 comprises a control section 253 as an information processing section inside. The control section 253, for instance, can be the control section of a semiconductor chip structure in which an action sequence is written, and also can be the control section of a microcomputer structure which works by storing an action program in the RAM (Random Access Memory) 254 and the like. Herein, the control section 253 of the microcomputer structure is described.

A CPU (Central Processing Unit) 255 forms the core of the control section 253. Moreover, the control section 253 is connected with an ROM (Read Only Memory) 256 unchangeably storing fixed data, the RAM 254 capable of storing variable data in a freely rewritable manner, a VRAM 257 for a displayed image generated on the LCD 210 to be displayed and an HDD 258 by a system bus 259 in the CPU 255.

In addition, in the settlement terminal 201, the control section 253 is connected with an interface 260 by the system bus 259, and the interface 260 mediates the data communication among the shooting section 203, the LCD 210, the touch panel 211, the card reader-writer 252, the receipt printer 251, the light-emitting section 218 and the charge machine 221. Moreover, the shooting section 203, the LCD 210, the touch panel 211, the card reader-writer 252, the receipt printer 251, the light-emitting section 218 and the interface 260 receive the control based on the control section 253. In addition, in the settlement terminal 201, the control section 253 is further connected with a communication interface 261 by the system bus 259. The communication interface 261 is connected with the communication network 41 to realize the data communication among the attendant terminal 501, the store controller 31 and the self checkout terminal 101. In addition, in the settlement terminal 201, although not shown in the figures, the control section 253 is further connected with an interface realizing the data communication between the control section 253 and the scale apparatus 301 by the system bus 259.

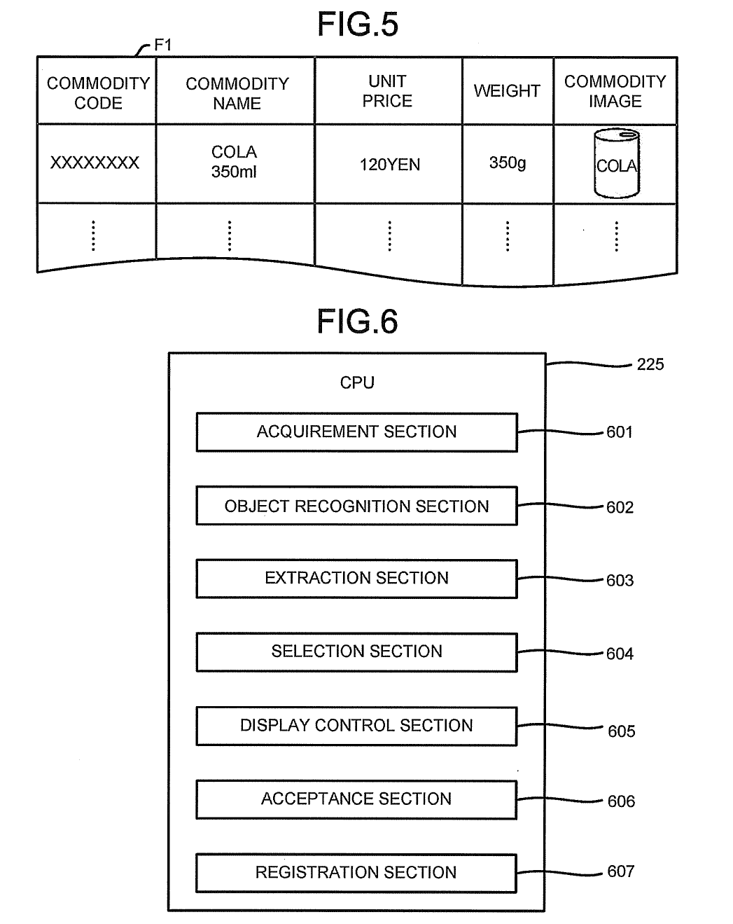

Besides storing a program enabling the control section 253 to work, the HDD 258 further stores a sales file and the like storing the commodity master file F1 (referring to FIG. 5), sales data and the like. FIG. 5 is a drawing describing the commodity master file. The commodity master file F1 is a store section correspondingly storing the commodity information satisfying the commodities, such as the commodity codes of the commodities, the commodity names of the commodities, the weights of the commodities or the unit prices (prices) of the commodities and the like and the commodity images of the commodities satisfied by the commodity information one to one.

Next, the functions of the settlement terminal 201 to which the present embodiment relates are described. FIG. 6 is a block diagram showing function compositions of the settlement terminal to which the present embodiment relates. The CPU 255 exerts functions as an acquirement section 601, an object recognition section 602, an extraction section 603, a selection section 604, a display control section 605, an acceptance section 606 and a registration section 607 as shown in FIG. 6 by working according to the program unfolded in the RAM 254 and stored in the HDD 258.

The acquirement section 601 outputs a shooting-on signal to the shooting section 203, so as to enable the shooting section 203 to begin a shooting action. Afterwards, the acquirement section 601 acquires the frame image of a shooting area shot by the shooting section 203 and stores the frame image in the RAM 254.

The object recognition section 602 reads a surface state such as a hue or a surface concave-convex status and the like from the frame image acquired by the acquirement section 601 as a characteristic quantity with reference to the commodity image stored in the commodity master file F1, so as to recognize the commodity as a specific object. In addition, in order to shorten the processing time of the recognition, the object recognition section 602 does not consider the contour or the size of the commodity.

The recognition carried out on an object included in the image in this way is called as generic object recognition. About the generic object recognition, various recognition technologies are explicated in the following document.

Yanai Keiji, “present state and perspectives of generic object recognition”, collected papers of information processing society, Vol. 48, No. SIG16 [retrieved on August 10, Heisei 22 (2010)], website <URL: http://mm.cs.uec.ac.jp/IPSJ-TCVIM-Yanai.pdf>.

In addition, the technology for the generic object recognition by carrying out area segmentation on the image according to the object is explicated in the following document.

Jamie Shotton and the like, “Semantic Texton Forests for Image Categorization and Segmentation”, [retrieved on August 10, Heisei 22 (2010)], website <URL: http://citeseerx.ist.psu.edu/viewdoc/download?doi=10.1.1.145.3036&rep=repl&type=pdf>.

The extraction section 603 extracts the commodity information satisfying the commodity recognized by the object recognition section 602 from the commodity master file F1. In the present embodiment, the extraction section 603 extracts the commodity information correspondingly stored one to one with the commodity images referred when the object recognition section 602 recognizes the commodity in the commodity master file F1 as the commodity information satisfying the commodity recognized by the object recognition section 602.

The selection section 604 receives the weight of the commodity measured by the scale apparatus 301 by an interface (not shown in the figures) realizing the data communication between the selection section 604 and the scale apparatus 301. Afterwards, the selection section 604 selects the commodity information including the weight approximately the same as the weight received from the scale apparatus 301 from the commodity information extracted by the extraction section 603. When the selection is carried out, the weight of the measured commodity is not necessary to be the same as the weight of the commodity included in the commodity information extracted from the commodity master file F1 definitely. For instance, the selection section 604, also can set a preset allowable error weight for each commodity, so as to select the commodity information including the weight of the commodity in the range of the allowable error weight by using the weight of the measured commodity in the commodity information extracted from the commodity master file F1 as reference. Thus, in the condition that a plurality of commodities are recognized by the object recognition section 602 according to one frame image, for instance, in the condition that a plurality of commodities with the same packages but different weights are recognized according to one frame image, the commodity subjected to the sales registration can be picked up from the plurality of recognized commodities, therefore, the customer does not need to select the expected commodity from the plurality of recognized commodities again, and thus, the burden of the customer can be lightened. Herein, the plurality of commodities with the same packages but different weights mean, for instance, as an example, by using plastic bottle commodities for beverages for describing, the commodities with the same packages but different weights and the like, such as 500 milliliters of plastic bottle commodities or 1 liter of plastic bottle commodities, belong to the commodities with the same packages but different weights. In addition, if the commodities are fruits and vegetables (as an example, using banana for describing), as the variety is the banana, the packages are the same, but as the banana which is below 200 grams and at a price of 99 yen and the banana which is above 300 grams and at a price of 199 yen, the commodities and the like whose prices are set to be different according to the weights of the commodities belong to the commodities with the same packages but different weights. In addition, the embodiment is recorded as an example but is not limited to this.

In the condition that multiple pieces of commodity information are selected by the selection sections 604, the display control section 605 displays the commodity information selected by the selection section 604 on the LCD 210. In the present embodiment, the display control section 605 displays the commodity name, the unit price, the weight and the like included in the commodity information selected by the selection section 604 as objects which can be satisfied by the touch panels 211 on the LCD 210. In addition, in the condition that multiple pieces of commodity information are selected by the selection section 604, the display control section 605 displays the selected commodity information on the LCD 210, but is not limited to this. For instance, in the condition that one piece of commodity information is selected by the selection section 604, the display control section 605 also can display the selected commodity information on the LCD 210. Thus, the customer can affirm whether or not the commodity information displayed on the LCD 210 is the commodity expected to carry out the sales registration by the customer.

The acceptance section 606 accepts the commodity information subjected to touch appointment by the touch panels 211 from the commodity information displayed on the LCD 210 as the commodity information satisfying the commodity subjected to the sales registration. In the condition that multiple pieces of commodity information are selected by the selection section 604, the customer needs to carry out the touch appointment on the expected commodity information from the commodity information displayed on the LCD 210, but the commodity information selected (namely, picked up) by the selection section 604 in the commodity information extracted by the extraction section 603 is displayed on the LCD 210, and therefore, the burden of the customer selecting the expected commodity information from the commodity information displayed on the LCD 210 can be lightened.

The registration section 607 carries out the sales registration on the commodity satisfied by the selected commodity information by recording the commodity information accepted by the acceptance section 606 in a sales master file and the like. In the present embodiment, the registration section 607 carries out the sales registration on the commodity by recording the commodity information accepted by the acceptance section 606 in the sales master file and the like. In addition, in the present embodiment, the registration section 607 stores the commodity information accepted by the acceptance section 606 in the sales master file, so as to carry out the sales registration of the commodity, but is not limited to this. For instance, in the condition that one piece of commodity information is selected by the selection section 604, the registration section 607 also can store the commodity information selected by the selection section 604 in the sales master file, so as to carry out the sales registration of the commodity.

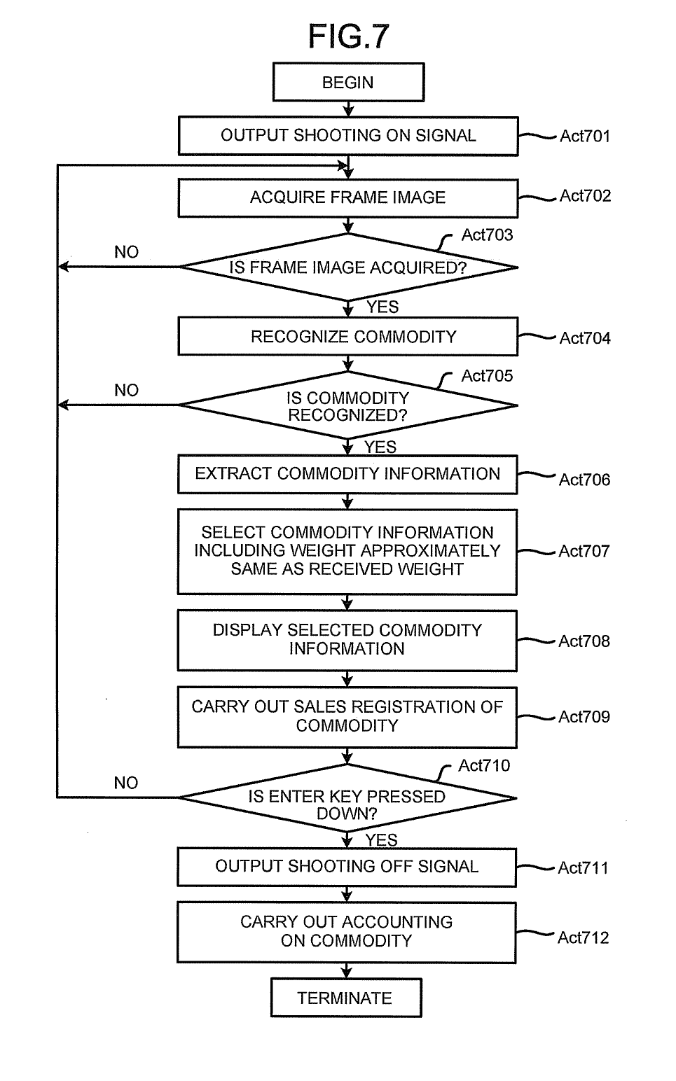

Next, the sales registration processing of the commodity carried out by the settlement terminal 201 is described by using FIG. 7. FIG. 7 is a flow chart showing the steps of the sales registration processing of the commodity carried out by the settlement terminal.

First, the acquirement section 601 outputs the shooting enabling signal to the shooting section 203, so as to enable the shooting section 203 to begin the shooting action (action 701). Afterwards, the acquirement section 601 acquires the frame image shot by the shooting section 203 (action 702)

Afterwards, in the condition that the frame image is not acquired (no of action 703), returning to action 702, the acquirement section 601 carries out the acquirement of the frame image shot by the shooting section 203. On the other hand, in the condition that the frame image is acquired (yes of action 703), the object recognition section 602 recognizes the commodity from the acquired frame image with reference to the commodity image stored in the commodity master file F1 (action 704). In the condition that the commodity is not recognized from the acquired frame image (no of action 705), returning to action 702, the acquirement section 601 carries out the acquirement of the frame image.

In the condition that the commodity is recognized from the acquired frame image (yes of action 705), the extraction section 603 extracts the commodity information of the recognized commodity from the commodity master file F1 (action 706). Next, the selection section 604 receives the weight of the commodity measured by the scale apparatus 301, and furthermore, selects the commodity information including the weight approximately the same as the received weight from the commodity information extracted by the extraction section 603 (action 707).

Once the commodity information is selected by the selection section 604, the display control section 605 displays the selected commodity information on the LCD 210 (action 708). The registration section 607 carries out the sales registration on the commodity satisfied by the selected commodity information by storing the commodity information subjected to the touch appointment by using the touch panels 211 in the commodity information displayed on the LCD 210 in the sales master file and the like (action 709).

Once the enter key displayed on the LCD 210 is pressed down after the sales registration of the commodity is executed (yes of 710), the acquirement section 601 outputs a shooting-off signal to the shooting section 203, so as to terminate the shooting action executed by the shooting section 203 (action 711). In addition, in the condition that the enter key displayed on the LCD 210 is pressed down (yes of action 710), the CPU 255 carries out accounting on the commodity subjected to the sales registration with reference to the commodity information stored in the sales master file (action 712). In addition, in the condition that the enter key displayed on the LCD 210 is not pressed down (no of action 710), returning to action 702, the acquirement section 601 carries out the acquirement of the frame image shot by the shooting section 203.

Thus, according to the self checkout terminal 101 to which the present embodiment relates, the frame image shot by the shooting section 203 is acquired, the commodity is recognized from the acquired frame image, the commodity information of the commodity recognized in the commodity master file F1 is extracted, the commodity information including the weight approximately the same as the weight measured by the scale apparatus 301 is selected from the extracted commodity information, the sales registration of the commodity satisfied by the selected commodity information is carried out, thus, in the condition that the plurality of commodities are recognized from the acquired frame image, the customer does not need to pick up the commodity subjected to the sales registration from the plurality of recognized commodities again, and therefore, the burden of the customer utilizing the self checkout terminal 101 can be lightened.

In addition, the program executed by the self checkout terminal 101 of the present embodiment is provided by being previously installed in the ROM and the like, but is not limited to this. The program executed by the self checkout terminal 101 of the present embodiment also can be provided by being recorded in a computer-readable recording medium such as a CD-ROM, a floppy drive (FD), a CD-R, a DVD (Digital Versatile Disk) and the like by using a file in an installable manner or an executable manner.

In addition, the program executed by the self checkout terminal 101 of the present embodiment also can be provided by being stored in a computer connected with a network such as the Internet and the like and being downloaded by the network. In addition, the program executed by the self checkout terminal 101 of the present embodiment also can be provided or allocated by the network such as the Internet and the like.

The program executed by the self checkout terminal 101 of the present embodiment is a module composition including all the sections (acquirement section 601, object recognition section 602, extraction section 603, selection section 604, display control section 605, acceptance section 606 and registration section 607), as actual hardware, the CPU reads out the program from the ROM and executes it, so that all the sections are loaded in a master store apparatus, and the acquirement section 601, the object recognition section 602, the extraction section 603, the selection section 604, the display control section 605, the acceptance section 606 and the registration section 607 are generated in the master store apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A self checkout terminal, comprising:
a measurement section configured to measure the weight of a commodity;
a shooting section configured to shoot an image;
a recognition unit configured to recognize the commodity from the shot image;
an extraction unit configured to extract the commodity information satisfying the recognized commodity from a commodity master file storing the commodity information including the weight of the commodity, wherein the commodity information is information satisfying the commodity;
a selection unit configured to select the commodity information including a weight approximately the same as the measured weight from the extracted commodity information; and
a registration unit configured to carry out sales registration on the commodity satisfied by the selected commodity information.

2. The self checkout terminal according to claim 1, further comprising:
a display control unit configured to display the selected commodity information on a display section in the condition that multiple pieces of commodity information are selected by the selection unit; and
an acceptance unit configured to accept the commodity information satisfying the commodity subjected to the sales registration from the commodity information displayed on the display section, wherein
the registration unit carries out the sales registration on the commodity satisfied by the accepted commodity information.

3. The self checkout terminal according to claim 2, wherein
the extraction unit extracts the commodity information satisfying the recognized commodity from the commodity master file storing the commodity information including a commodity name, the weight of the commodity and the sum of the commodity, and
the display control unit displays the commodity name, the weight of the commodity and the sum of the commodity included in the selected commodity information on the display section.

4. A method, comprising:
measuring the weight of a commodity;
shooting an image;
recognizing the commodity from the shot image;
extracting the commodity information satisfying the recognized commodity from a commodity master file storing the commodity information including the weight of the commodity, wherein the commodity information is information satisfying the commodity;
selecting the commodity information including a weight approximately the same as the measured weight from the extracted commodity information; and
carrying out sales registration on the commodity satisfied by the selected commodity information.

5. The method according to claim 4, further comprising:
displaying the selected commodity information on a display section in the condition that multiple pieces of commodity information are selected by the selection unit; and
accepting the commodity information satisfying the commodity subjected to the sales registration from the commodity information displayed on the display section, wherein
carrying out the sales registration on the commodity satisfied by the accepted commodity information.

6. The method according to claim 5, wherein
extracting the commodity information satisfying the recognized commodity from the commodity master file storing the commodity information including a commodity name, the weight of the commodity and the sum of the commodity, and
displaying the commodity name, the weight of the commodity and the sum of the commodity included in the selected commodity information on the display section.
